(19) United States
(12) Patent Application Publication
(10) Pub. No.: US 2026/0290963 A1
(43) Pub. Date: Sep. 24, 2026

(54) TOP COVER ASSEMBLY, SECONDARY BATTERY, AND POWER CONSUMPTION APPARATUS

(71) Applicant: CONTEMPORARY AMPEREX TECHNOLOGY (HONG KONG) LIMITED, HONG KONG (CN)

(72) Inventors: Xinxiang CHEN, Ningde (CN); Shoujun HUANG, Ningde (CN); Huasheng SU, Ningde (CN); Yulian ZHENG, Ningde (CN); Xiang LI, Ningde (CN)

(73) Assignee: CONTEMPORARY AMPEREX TECHNOLOGY (HONG KONG) LIMITED, HONG KONG (CN)

(21) Appl. No.: 19/631,575

(22) Filed: Mar. 27, 2026

Related U.S. Application Data
(63) Continuation of application No. 17/505,753, filed on Oct. 20, 2021, now abandoned.
Application No. 17/505,753 is a continuation of application No. PCT/CN2020/113946, filed on Sep. 8, 2020.

(30) Foreign Application Priority Data
Sep. 11, 2019 (CN) 201921510303.2

(51) Int. Cl. H01M 50/188; H01M 50/15; H01M 50/159; H01M 50/528; H01M 50/543

(52) U.S. Cl. CPC H01M 50/188; H01M 50/15; H01M 50/159; H01M 50/528; H01M 50/543

(57) ABSTRACT

A top cover assembly includes a top cover plate, a pole, a sealing ring, a first insulating member and a second insulating member. The top cover plate is provided with a mounting hole including a sealing hole section. The pole includes a first section, a second section and a sealing shaft section. The sealing shaft section is configured to be inserted into the sealing hole section. Side walls of the sealing shaft section and the sealing hole section are both tilted with respect to an axis of the mounting hole. A restraint protrusion of the first insulating member, an end of the second insulating member facing towards the pole, the side wall of the sealing hole section, and the side wall of the sealing shaft section together define a sealing cavity. The sealing ring is entirely disposed within the sealing cavity in a compressed state.

### CROSS-REFERENCE TO RELATED APPLICATION

This application is a Continuation of U.S. Patent Application No. 17/505,753, filed on October 20, 2021, which claims the benefit of priority to International Patent Application No. PCT/CN2020/113946, filed on September 08, 2020, which in turn claims the benefit of priority to Chinese Patent Application No. CN 201921510303.2, filed on September 11, 2019. The entire contents of each of the above-referenced applications are hereby incorporated herein by reference in their entirety.

### BACKGROUND

A secondary battery includes a cover assembly, a housing, and an electrode assembly. The electrode assembly is accommodated in the housing, the top cover assembly is mounted at a top part of the housing and electrically connected to the electrode assembly, so that electric energy of the electrode assembly is introduced to the outside of the housing through a pole on the top cover assembly.

A top cover plate is provided with a mounting hole. Under normal conditions, the pole is sealed and connected to the inside the mounting hole through a sealing ring so as to ensure the sealing performance between the top cover assembly and the pole. However, there is a technical problem of inconvenient mounting when mounting the sealing ring.

### SUMMARY

The present application relates to the technical field of energy storage devices, and in particular, to a top cover assembly, a secondary battery, and a power consumption apparatus.

Embodiments of the present application provide a top cover assembly, a secondary battery, and a power consumption apparatus, so as to improve the convenience of mounting the sealing ring.

A first aspect of the embodiments of the present application provides a top cover assembly, which includes:

a top cover plate, the top cover plate being provided with a mounting hole, and the mounting hole includes a sealing hole section;

a pole, including a first section, a second section and a sealing shaft section, the sealing shaft section is configured to be inserted into the sealing hole section, a side wall of the sealing hole section and a side wall of the sealing shaft section are both tilted with respect to an axis of the mounting hole, the first section directly extends from a bottom end of the pole to the sealing shaft section and has a cylindrical shape, the second section directly extends from a top end of the pole to the sealing shaft section and has a cylindrical shape, a diameter of the first section is greater than a diameter of the second section, the first section transitions to the second section through the sealing shaft section, the sealing shaft section is tapered in a direction pointing from the first section towards the second section, a maximum diameter of the sealing shaft section is equal to the diameter of the first section, and a minimum diameter of the sealing shaft section is equal to the diameter of the second section;

a sealing ring, disposed between the side wall of the sealing hole section and the side wall of the sealing shaft section; and

a first insulating member and a second insulating member, the first insulating member is located on a side of the top cover plate facing towards the first section of the pole, and the second insulating member is located on a side of the top cover plate facing towards the second section of the pole;

the first insulating member is provided with a restraint protrusion extending into the mounting hole and located between the side wall of the mounting hole and the second section of the pole;

the restraint protrusion of the first insulating member, an end of the second insulating member facing towards the pole, the side wall of the sealing hole section, and the side wall of the sealing shaft section together define a sealing cavity, a top boundary of the sealing cavity is defined by a bottom surface of the restraint protrusion, a first lateral boundary of the sealing cavity is defined by the side wall of the sealing shaft section, a second lateral boundary of the sealing cavity is defined by the side wall of the sealing hole section, a bottom boundary of the sealing cavity is defined by a top surface of the second insulating member, the sealing ring is entirely disposed within the sealing cavity in a compressed state.

A second aspect of the embodiments of the present application provides a secondary batter, which includes any one top cover plate provided by the present application.

A third aspect of the embodiments of the present application provides a power consumption apparatus, which includes the secondary battery provided by the present application, and the secondary battery is configured to provide electric energy.

### BRIEF DESCRIPTION OF THE DRAWINGS

The accompanying drawings herein, which are incorporated in and constitute a part of the specification, illustrate embodiments that conform to the present application, and serve to explain the principles of the present application in combination with the specification.

In order to illustrate the technical solution in the embodiments of the present application more clearly, brief description will be made below to the drawings required in the embodiments of the present application, and apparently, the drawings described below are some embodiments of the present application only, and other drawings could be obtained based on these drawings by those ordinary skilled in the art without creative efforts.

FIG. 1 is a schematic structure diagram of a secondary battery provided by an embodiment of the present application;

FIG. 2 is an exploded schematic structure diagram of a secondary battery provided by an embodiment of the present application;

FIG. 3 is an exploded schematic structure diagram of a top cover assembly provided by an embodiment of the present application;

FIG. 4 is a schematic profile structure diagram of a top cover assembly provided by an embodiment of the present application;

FIG. 5 is a locally enlarged view of FIG. 4;

FIG. 6 is a schematic diagram of a partial structure of a top cover plate in FIG. 5;

FIG. 7 is a schematic structure diagram of a pole in FIG. 5;

FIG. 8 is a schematic diagram of a fitting structure of a top cover plate and a pole in FIG. 5;

FIG. 9 is a schematic diagram of a fitting structure of a top cover plate, a pole, a first insulating member, and a second insulating member in FIG. 5; and

FIG. 10 is a schematic diagram of a partial structure of a first insulating member in FIG. 5.

### REFERENCE SIGNS

1—Top cover assembly;

10—Top cover plate;

100—Mounting hole;

100a—Sealing hole section;

100b—Restraint hole section;

101—Sealing cavity;

101a—Top boundary of the sealing cavity;

101b—Bottom boundary of the sealing cavity;

101c—First lateral boundary of the sealing cavity;

101d—Second lateral boundary of the sealing cavity;

102—Gap;

103—Flange

11—Pole;

110—Sealing shaft section;

111—First section;

112—Second section;

12—Sealing ring;

13—First insulating member;

130—Restraint protrusion;

131—Positioning groove;

14—Second insulating member;

15—Terminal board;

16—Adapting sheet;

17—Explosion-proof valve;

18—Explosion-proof valve patch;

19—Injection hole;

2—Housing;

3—Electrode assembly; and

4—Insulating membrane.

### DETAILED DESCRIPTION

To make the objectives, technical solutions, and advantages of the present application clearer and more comprehensible, the present application will be further described below in detail with reference to the accompanying drawings and embodiments. It should be understood that the specific embodiments described herein are merely used to explain the present application, but are not intended to limit the present application.

In the description of the present application, unless otherwise specified and limited explicitly, the terms such as “first” and “second” are merely intended for a purpose of description, and shall not be understood as an indication or implication of relative importance. Unless otherwise specified or illustrated, the term “a plurality of” refers to two or more; the terms “connection” and “fixing” should be understood broadly, for example, the “connection” may either be a fixed connection, or a detachable connection, or an integrated connection, or an electrical connection; and the “connection” may either be a direction connection, or an indirect connection through an intermediary. Those of ordinary skill in the art may appreciate the specific meanings of the foregoing terms in the present application according to specific circumstances.

In the description of the specification, it should be understood that the terms representing directions such as “up” and “down” described in the embodiments of the present application are described from the angles shown in the accompanying drawings, and should not be understood as limitation on the embodiments of the present application. In addition, in the context, it should also be understood that when it is mentioned that an element is connected “on” or “under” another element, it can not only be directly connected “on” or “under” another element, but also be indirectly connected “on” or “under” another element through an intermediate element.

An inventor found that when a pole is sealed and connected to a mounting hole through a sealing ring, usually, the sealing ring is L-shaped in cross-section (hereinafter referred to as “L-shaped sealing ring”). The upper half portion of the L-shaped sealing ring (that is, the vertical arm portion of the “L” shape) extending into the mounting hole and the lower half portion (that is, the bottom arm portion of the “L” shape) located at one side of the top cover plate in a thickness direction. The L-shaped sealing ring is sealed by squeezing the lower half portion of sealing ring by the force of the secondary battery in a height direction. The lower half portion of the L-shaped sealing ring is located at one side of the top cover plate, which occupies the space in the height direction, resulting in a reduction in the energy density of the secondary battery. By removing the lower half portion of the L-shaped sealing ring, only the portion of the sealing ring located in the mounting hole is remained, i.e. the shape of the cross-section is changed to an approximate “O” shape, hereinafter referred to as the “O-shaped sealing ring”, so as to improve the energy density of the secondary battery. The inventor found that this structure has a technical problem of inconvenient mounting of the sealing ring. Based on the inventor's findings, the present application provides a new top cover assembly to improve the convenience of the mounting of the sealing ring.

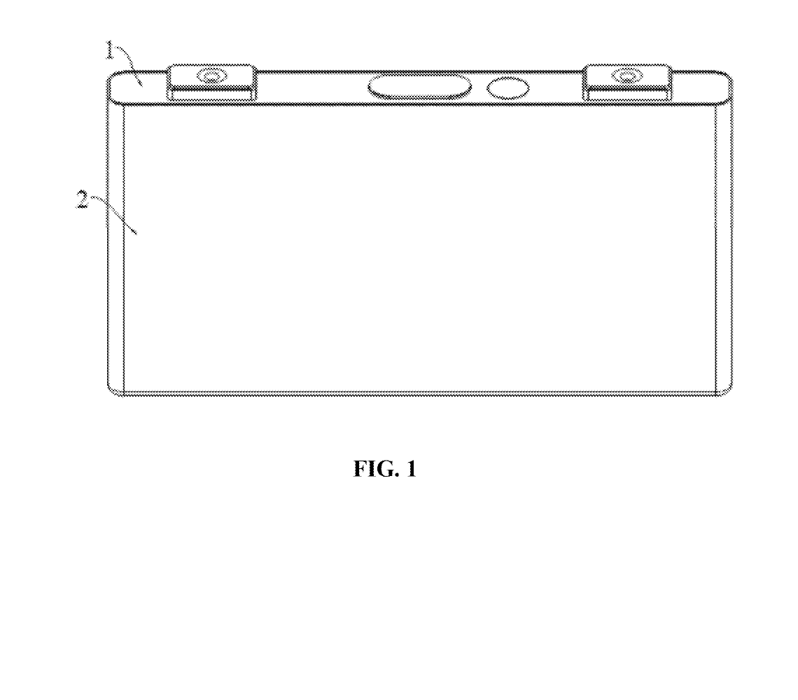

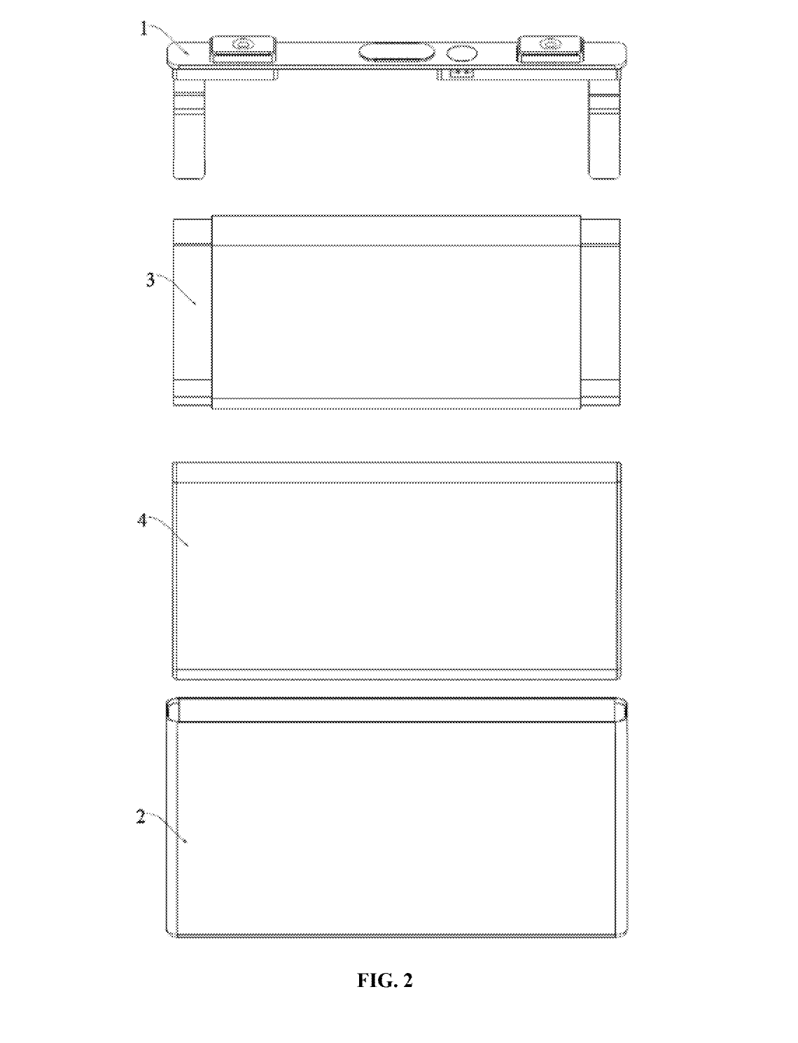

As shown in FIGS. 1 and 2, embodiments of the present application provide a secondary battery, including a top cover assembly 1, a housing 2 and an electrode assembly 3. Where, the housing 2 can be a hexahedral shape or other shapes, and an accommodating cavity is formed inside the housing 2 to accommodate the electrode assembly 3 and electrolyte. There is an opening at an end of the housing 2 so that the electrode assembly 3 can be placed in the accommodating cavity in the housing 2 through the opening, and the accommodating cavity can be provided with a plurality of electrode assemblies 3, and the plurality of electrode assemblies 3 are stacked on each other. Where, the housing 2 may include a metallic material, such as aluminium or aluminium alloy, etc., or it may include an insulating material, such as plastic, etc. When the housing 2 includes a metallic material, an insulating membrane 4 may be provided in the housing 2.

The electrode assembly includes an electrode unit and tabs, and the tabs may be disposed at two end parts of the electrode unit, or may be disposed at intervals on a top part of the electrode unit. The electrode unit includes a positive electrode plate, a negative electrode plate, and a separator. The separator is located between adjacent positive electrode plate and negative electrode plate to separate the positive electrode plate from the negative electrode plate.

In a possible design, the positive electrode plate, the separator, and the negative electrode plate are stacked in sequence and wound to form the electrode unit of the electrode assembly 3, that is, the electrode unit is a winding structure. In another possible design, the positive electrode plate, the separator, and the negative electrode plate are stacked in sequence to form the electrode unit of the electrode assembly, and the electrode unit is a laminated structure. In the meantime, the electrode unit is formed with a gap, through which the electrolyte can enter the electrode unit and infiltrate the positive electrode plate and the negative electrode plate.

Where, the positive electrode plate includes a positive electrode current collector (for example, aluminium foil) and a layer of positive active substance (for example, ternary material, lithium iron phosphate, or lithium cobaltate) coated on a surface of the positive electrode current collector. The negative electrode plate includes a negative electrode current collector (for example, copper foil) and a layer of negative active substance (for example, graphite, carbon, or silicon) coated on a surface of the negative electrode current collector. At the positive electrode of the electrode assembly 3, the tab is connected to the positive electrode plate and extends from the electrode unit, and the tab may be formed by directly cutting the positive electrode current collector. At the negative electrode of the electrode assembly 3, the tab is connected to the negative electrode plate and extends from the electrode unit, and the tab may be formed by directly cutting the negative electrode current collector.

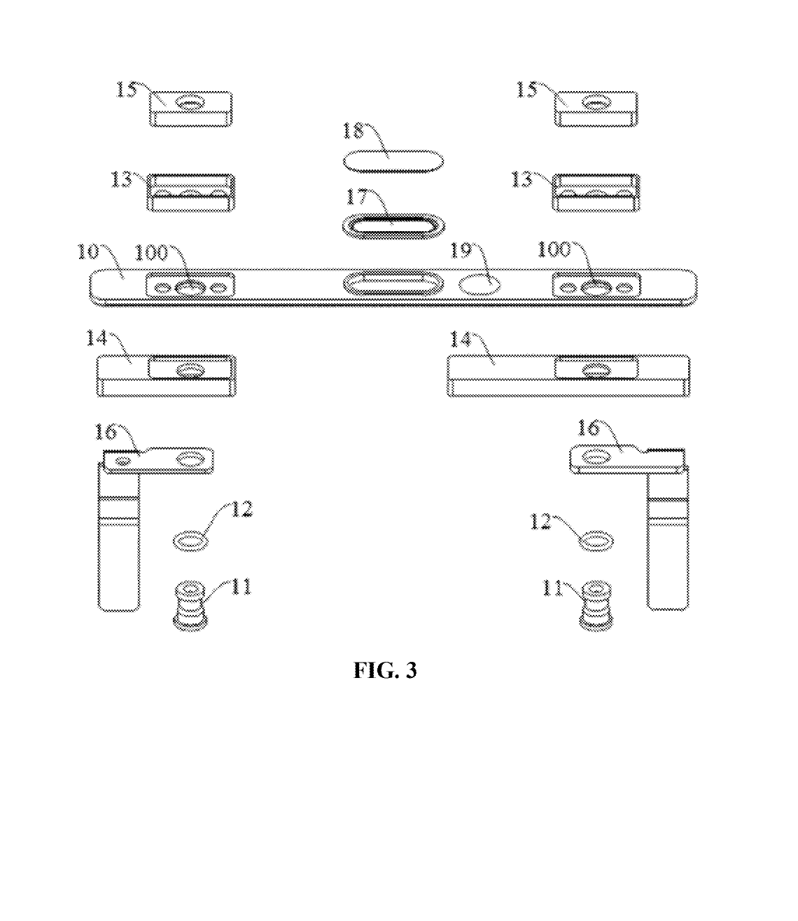

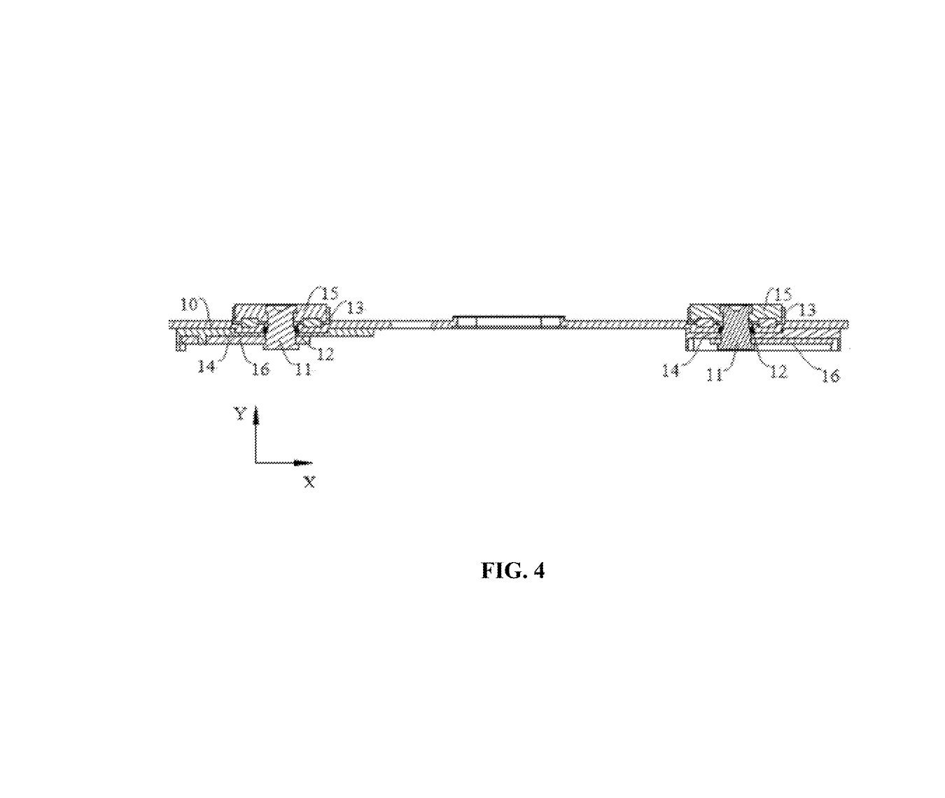

As shown in FIGS. 3 to 5, the top cover assembly 1 provided in the embodiments of the present application includes a top cover plate 10, poles 11 and sealing rings 12. The top cover plate 10 is fixed at the opening of the housing 2. A length direction of the top cover plate 10 is the direction X shown in FIG. 4, and a thickness direction of the top cover plate 10 is the direction Y shown in FIG. 4. The top cover plate 10 is provided with an explosion-proof valve 17 and an explosion-proof valve patch 18 so as to enclose the electrode assembly and the electrolyte in the accommodating cavity of the housing 2. The top cover plate 10 is also provided with an injection hole 19 to inject the electrolyte into the accommodating cavity of the housing 2. The top cover plate 10 is provided with mounting holes 100, and the mounting holes 100 penetrate the top cover plate 10 in the thickness direction (direction Y). The poles 11 are inserted into the mounting holes 100, sealed and connected to the inside of the mounting holes 100, and the poles 11 can be riveted to the top cover plate 10 through terminal boards 15. The poles 11 include a positive electrode pole and a negative electrode pole, and the two electrode poles 11 are electrically connected to the corresponding tab through adapting sheets 16. Similarly, the adapting sheets 16 include a positive electrode adapting sheet and a negative electrode adapting sheet.

Where, a mounting hole 100 includes a sealing hole section 100a, a pole 11 includes a first section 111, a second section 112 and a sealing shaft section 110, the sealing shaft section 110 is inserted into the sealing hole section 100a, and a side wall of the sealing hole section 100a and a side wall of the sealing shaft section 110 are both tilted with respect to an axis of the mounting hole 100. The first section 111 directly extends from a bottom end of the pole 11 to the sealing shaft section 110 and has a cylindrical shape, the second section 112 directly extends from a top end of the pole 11 to the sealing shaft section 110 and has a cylindrical shape. A diameter of the first section 111 is greater than a diameter of the second section 112, the first section transitions 111 to the second section 112 through the sealing shaft section 110. The sealing shaft section 110 is tapered in a direction pointing from the first section 111 towards the second section 112. A maximum diameter of the sealing shaft section 110 is equal to the diameter of the first section 111, and a minimum diameter of the sealing shaft section 110 is equal to the diameter of the second section 112. A gap is provided between the sealing hole section 100a and the sealing shaft section 110. A sealing ring 12 is provided between the side wall of the sealing hole section 100a and the side wall of the sealing shaft section 110, that is, the sealing ring 12 is disposed in the above gap.

During the mounting, the sealing ring 12 is inserted into the mounting hole 100 along an end of the mounting hole 100 having a larger diameter, and an end of the pole 11 having a smaller diameter is mounted into an inner ring of the sealing ring 12 so that the sealing ring 12 is positioned between the sealing hole section 100a and the sealing shaft section 110. When the pole 11 is inserted into the mounting hole 100 along a direction of the axis of the mounting hole 100, the distance between the side wall of the sealing hole section 100a and the side wall of the sealing shaft section 110 gradually decreases, creating a squeeze to the sealing ring 12 along a direction perpendicular to the side wall until the sealing ring 12 is mounted in place. It is convenient to mount and can effectively avoid displacement or damage of the sealing ring 12 during the mounting procedure of the pole 11.

In addition, since the side wall of the sealing hole section 100a and the side wall of the sealing shaft section 110 are both tilted with respect to the axis of the mounting hole 100, the distance between the two along the direction perpendicular to the side wall is less than the distance between the two along the radial direction of the mounting hole 100, thus enabling a greater squeezing effect on the sealing ring 12, and achieving a reliable sealing performance.

In some embodiments, “the side wall of the sealing hole section 100a and the side wall of the sealing shaft section 110 are both tilted with respect to the axis of the mounting hole 100” means that along the thickness direction of the top cover plate 10, an aperture of the sealing hole section 100a gradually changes, a shaft diameter of the sealing shaft section 110 gradually changes, so that the sealing hole section 100a and the sealing shaft section 110 both present a structure with an large end and an small end.

Where, along the thickness direction of the top cover plate 10, the aperture of the sealing hole section 100a and the shaft diameter of the sealing shaft section 110 may be changed linearly such that a generatrix of the sealing hole section 100a and a generatrix of the sealing shaft section 110 are both straight lines. The aperture of the sealing hole section 100a and the shaft diameter of the sealing shaft section 110 may also change non-linearly such that the generatrix of the sealing hole section 100a and the generatrix of the sealing shaft section 110 may be non-straight lines (for example, a curve line or a broken line, etc.).

In some embodiments, along the thickness direction of the top cover plate 10, a distance (a distance along the radial direction of the mounting hole 100) between the side wall of the sealing hole section 100a and the side wall of the sealing shaft section 110 is the same everywhere. That is, at any thickness position of the top cover plate 10, the distance between the sealing hole section 100a and the sealing shaft section 110 along the radial direction of the mounting hole 100 is the same. Accordingly, a uniform mounting gap is formed between the sealing hole section 100a and the sealing shaft section 110. The sealing ring 12 is disposed between the side wall of the sealing hole section 100a and the side wall of the sealing shaft section 110, and a uniform mounting gap is formed between the sealing hole section 100a and the sealing shaft section 110, so that the sealing ring 12 can be uniformly compressed and ensure the sealing effect.

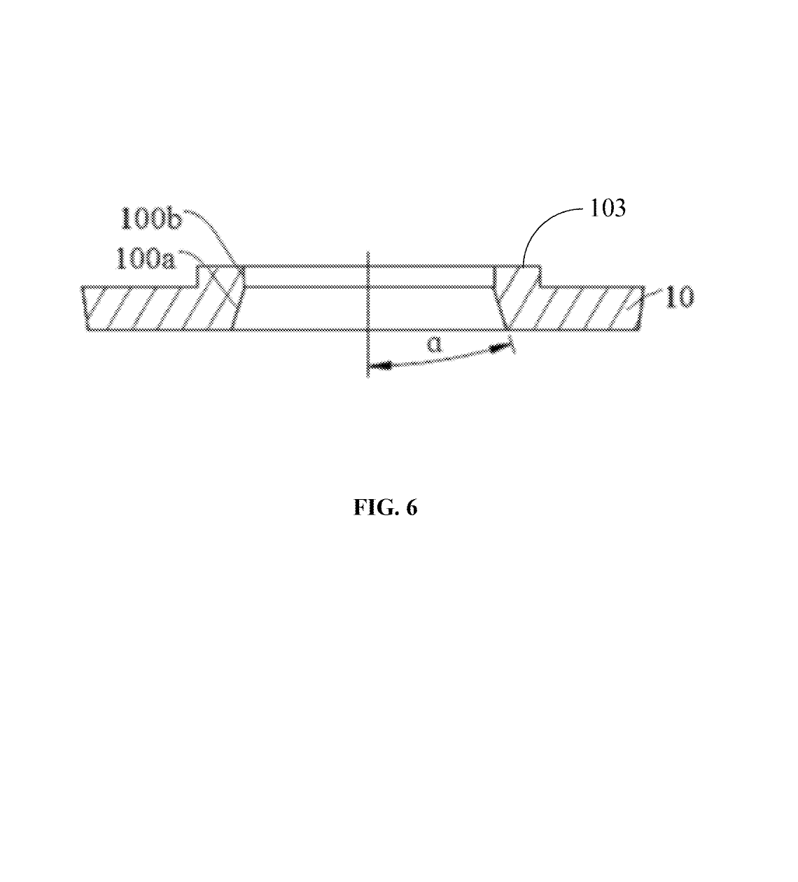

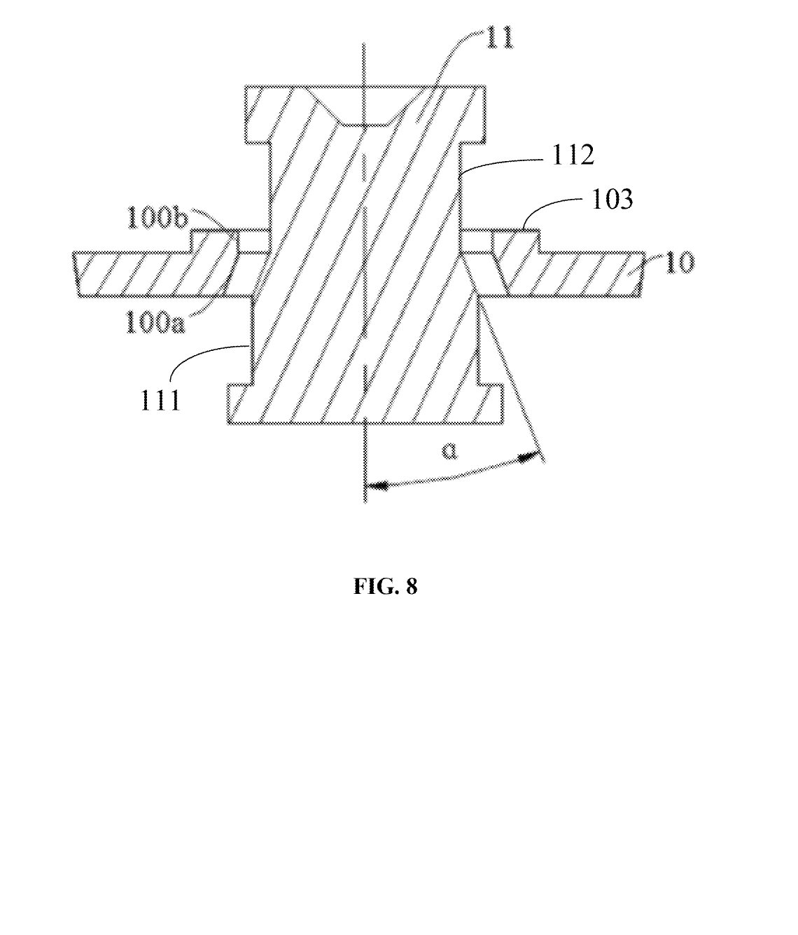

As shown in FIGS. 6 to 8, in some embodiments, the generatrix of the sealing hole section 100a and the generatrix of the sealing shaft section 110 are both straight lines. That is, the sealing hole section 100a is a circular table shaped hole, and the sealing shaft section 110 is a circular table shaped shaft, of which the structure is simple and facilitates the process. The generatrix of the sealing hole section 100a is parallel to the generatrix of the sealing shaft section 110, so that the sealing ring 12 can be uniformly compressed between the sealing hole section 100a and the sealing shaft section 110. During the process of the pole 11 being inserted into the mounting hole 100 and squeezing the sealing ring 12, the sealing ring 12 can be facilitated to move along the side wall, such that the sealing ring 12 moves from the ends having smaller diameter to the ends having lager diameter of the sealing hole section 100a and the sealing shaft section 110, so the sealing ring 12 can be fully compressed and the reliability of the sealing can be increased.

In some embodiments, along a direction (direction Y) pointing from a bottom part to a top part of the top cover plate 10, the side wall of the sealing hole section 100a and the side wall of the sealing shaft section 110 are both tilted in a direction close to the axis of the mounting hole 100. That is, the sealing hole section 100a and the sealing shaft section 110 both have a structure that is small on the top and large on the bottom, and a bottom end of the sealing hole section 100a and a bottom end of the sealing shaft section 110 are ends having larger diameter, and the top ends are ends having smaller diameter. The pole 11 is mounted into the mounting hole 100 from bottom to top, and is fixed at the top part of the top cover plate 10, so that it is more convenient to mount and fix the pole 11. In addition, since a bottom end of the pole 11 needs to be connected to an adapting sheet 16, and connected to the tab of the electrode assembly 3 through the adapting sheet 16. The pole 11 is mounted into the mounting hole 100 from bottom to top, which can prevent deformation or movement of the adapting sheet 16 during the mounting of the pole 11.

Of course, the sealing hole section 100a and the sealing shaft section 110 may further be configured to present structures that are large on the top and small on the bottom, so that top ends of the sealing hole section 100a and the sealing shaft section 110 are ends having larger diameter, and bottom ends are ends having smaller diameter, and the pole 11 is mounted into the mounting hole 100 from bottom to top.

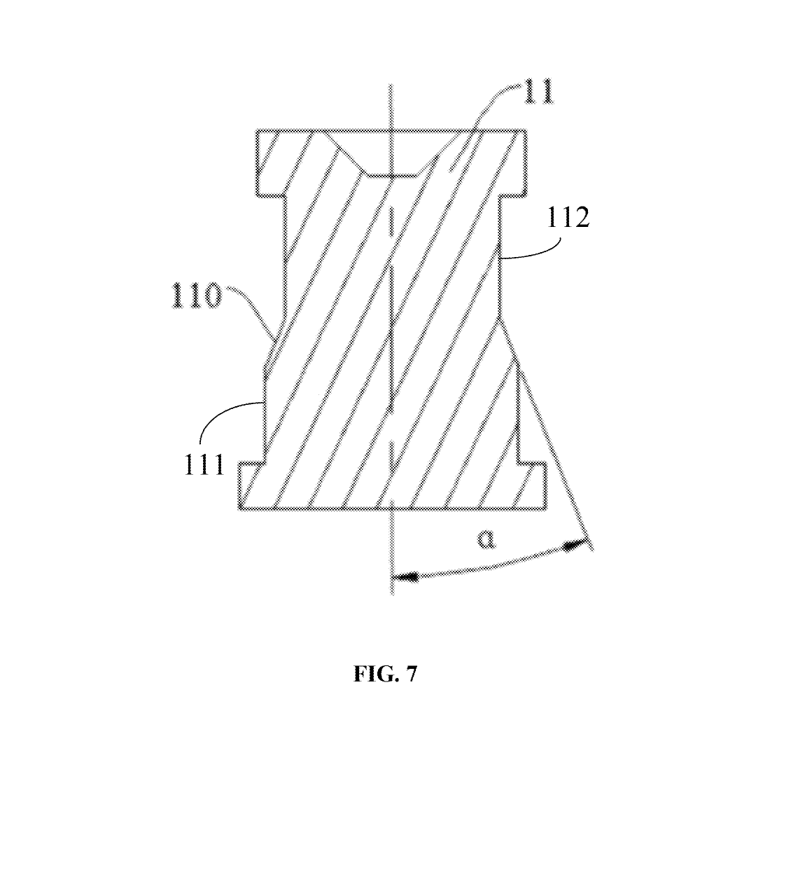

In some embodiments, as shown in FIG. 7, the side wall of the sealing hole section 100a and the side wall of the sealing shaft section 110 are tilted with respect to the axis of the mounting hole 100 at an angle α of 5° to 45°, which can not only facilitate the mounting of the sealing ring 12, but further ensure the reliability of the sealing performance of the sealing ring 12. When α is less than 5°, since a small thickness of the top cover plate 10, the diameter of two ends of the sealing hole section 100a is almost the same as the diameter of two ends of the sealing shaft section 110, which is still not convenient for the mounting of the sealing ring 12. When α is greater than 45°, the distance between the sealing hole section 100a and the sealing shaft section 110 perpendicular to the side wall is too small, which will easily lead to excessive compression of the sealing ring 12 and produce damage, thus affecting the reliability of the sealing performance.

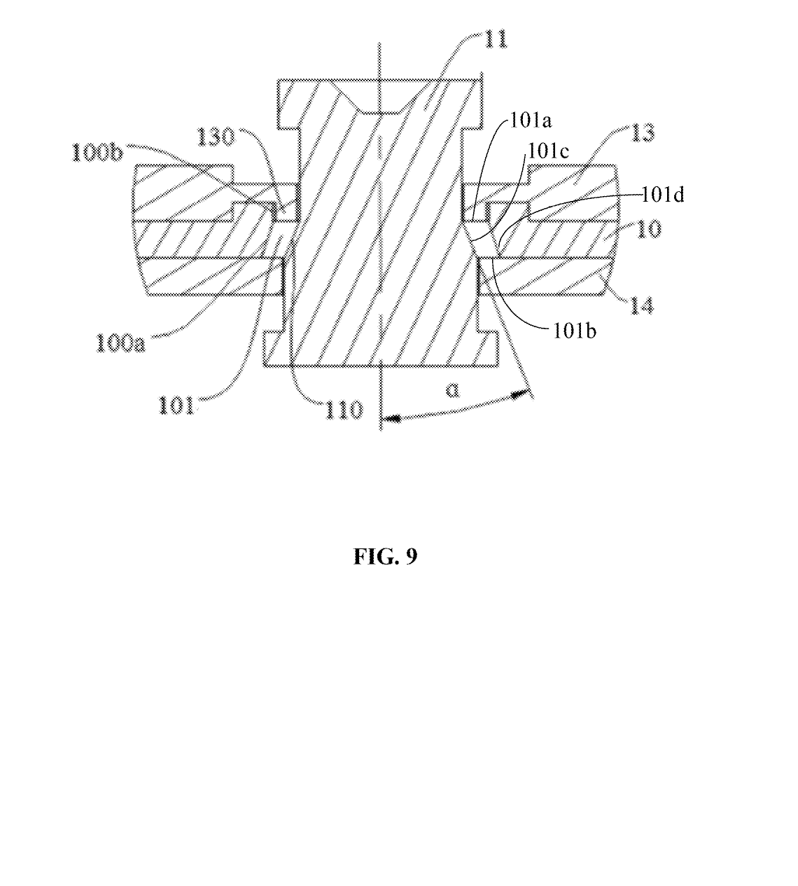

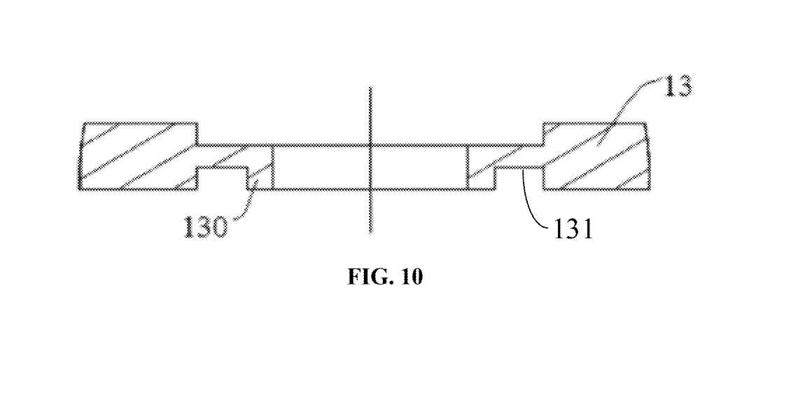

As shown in FIGS. 3, 5, 9, and 10, the top cover assembly 1 provided by the embodiments of the present application further includes a first insulating member 13 and a second insulating member 14. The first insulating member 13 and the second insulating member 14 are respectively located at both sides of the top cover plate 10 along the thickness direction thereof and fixed with respect to the top cover plate 10. Specifically, the first insulating member 13 is located on a side of the top cover plate 10 facing towards the first section 111 of the pole 11, and the second insulating member 14 is located on a side of the top cover plate 10 facing towards the second section 112 of the pole 11. Through holes are respectively provided on the first insulating member 13 and the second insulating member 14, allowing the pole 11 to penetrate. A fixation is formed to the pole 11 by the first insulating member 13 and the second insulating member 14 to prevent the pole 11 from wobbling in the mounting hole 100.

In one embodiment, the top cover plate 10 is made of metallic material. The first insulating member 13 and the second insulating member 14 can further achieve the insulation between the pole 11 and the top cover plate 10, and avoid the short circuit caused by the contact between the pole 11 and the top cover plate 10.

In another embodiment, the top cover plate 10 is made of an insulating material. The first insulating member 13 and the second insulating member 14 can be provided as independent components from the top cover plate 10 or can be integrally formed with the top cover plate 10.

The first insulating member 13, the second insulating member 14, the side wall of the sealing hole section 100a, and the side wall of the sealing shaft section 110 form a sealing cavity 101, and the sealing ring 12 is located in the sealing cavity 101. The first insulating member 13 and the second insulating member 14 form a restraint on the sealing ring 12 at the two ends of the mounting hole 100 along the axis direction respectively, to prevent the sealing ring 12 from slipping off along an end part of the sealing hole section 100a during the process of the pole 11 being inserted into the mounting hole 100 and squeezing the sealing ring 12. This affects an effective contact area between the sealing ring 12 and the sealing hole section 100a and an effective contact area between the sealing ring 12 and the sealing shaft section 110, thereby improving the reliability of the sealing performance.

Further, a thickness of the sealing ring 12 is not greater than a thickness of the top cover plate 10. A top part of the sealing ring 12 does not exceed a top part of the top cover plate 10, and a bottom part of the sealing ring 12 does not exceed a bottom part of the top cover plate 10. The sealing ring 12 is completely accommodated in the sealing hole section 100a along the thickness direction of the top cover plate 10. In this way, not only can the sealing ring 12 be fully compressed to improve an effective utilization rate of the sealing ring 12, that is, a portion of the sealing ring 12 exceeds the sealing hole section 100a cannot be compressed or fully compressed, so that this portion cannot have a sealing effect; but also, an overall thickness of the top cover assembly 1 can be reduced, and the energy density of the secondary battery can be improved.

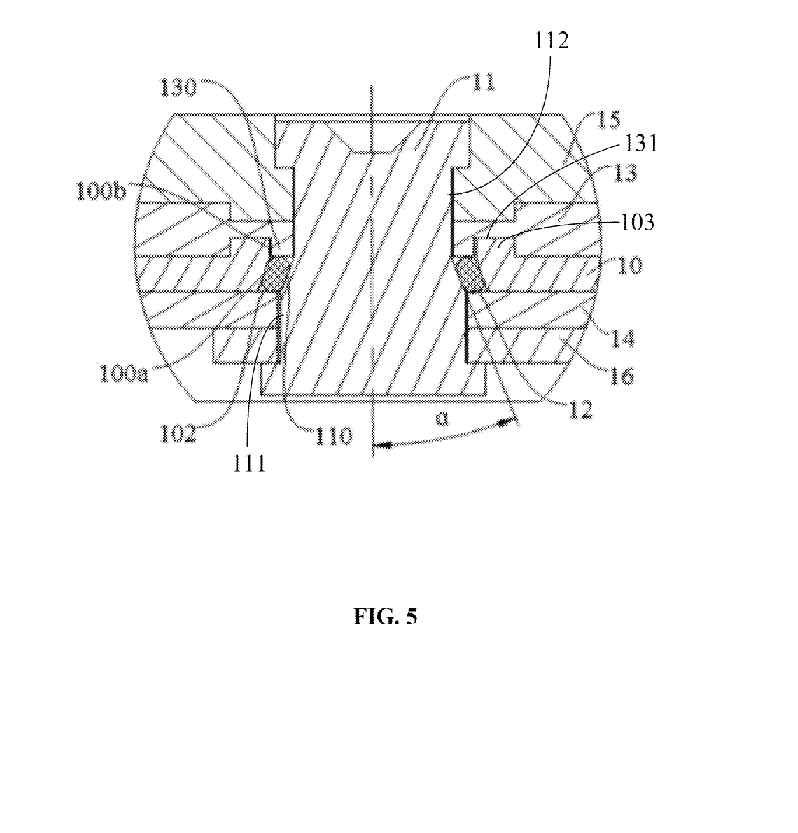

Further, a gap 102 (refer to FIG. 5) is left between at least one top corner of the sealing cavity 101 and the sealing ring 12, and the gap 102 allows an elastic restoring force of the sealing ring 12 to be released, thereby avoiding damage to the sealing ring 12 under excessive pressing force.

Further, the first insulating member 13 is disposed at an end of the sealing hole section 100a having a smaller diameter end, that is, the first insulating member 13 is disposed at an end of the mounting hole 100 having a smaller diameter. Accordingly, the second insulating member 14 is disposed at an end of the sealing hole section 100a having a larger diameter. The mounting hole 100 further includes a restraint hole section 100b, and the restraint hole section 100b is disposed at an end of the sealing hole section 100a facing the first insulating member 13, and communicated with the sealing hole section 100a. A sharp edge of the sealing hole section 100a are eliminated by means of the restraint hole section 100b. That is, when the sealing hole section 100a penetrates the top cover plate 10 along the thickness direction of the top cover plate 10, a sharp acute angle is formed between an inner wall of the end of the sealing hole section 100a having a smaller diameter and the surface of the top cover plate 10, which easily causes damage to the edge of the sealing hole section 100a or scratches on the sealing ring 12. A restraint hole section 100b is provided at an end of the sealing hole section 100a having a smaller diameter, so an obtuse angle is formed between an inner wall of the sealing hole section 100a and an inner wall of the restraint hole section 100b, which effectively prevents damage to an edge of the sealing hole section 100a and scratches on the sealing ring 12.

The first insulating member 13 is provided with a restraint protrusion 130, and the restraint protrusion 130 is located between the restraint hole section 100b and the pole 11 (an annular gap between the restraint hole section 100b and the pole 11). On the one hand, the restraint protrusion 130 forms a reliable positioning and insulation between the top cover plate 10 and the pole 11, preventing the pole 11 from wobbling or short-circuiting with the top cover plate 10; on the other hand, the sealing ring 12 is ensured to be completely accommodated in the sealing hole section 100a, forming a reliable sealing performance.

In one example, the restraint protrusion 130 of the first insulating member 13, an end of the second insulating member 14 facing towards the pole 11, the side wall of the sealing hole section 100a, and the side wall of the sealing shaft section 110 together define a sealing cavity 101. A top boundary 101a of the sealing cavity 101 is defined by a bottom surface of the restraint protrusion 130, a first lateral boundary 101c of the sealing cavity 101 is defined by the side wall of the sealing shaft section 110, a second lateral boundary 101d of the sealing cavity 101 is defined by the side wall of the sealing hole section 100a, a bottom boundary 101b of the sealing cavity 101 defined by a top surface of the second insulating member 14. The sealing ring 12 is entirely disposed within the sealing cavity 101 in a compressed state.

In one example, an end of the restraint hole section 100b away from the sealing hole section 100a forms a flange 103, and the first insulating member 13 is provided with a positioning groove 131 in which the flange 103 is received.

Embodiments of the present application further provides a power consumption apparatus, which includes the secondary battery in the above embodiments, and the secondary battery is configured to provide electric energy.

Where, the power consumption apparatus may be a vehicle, for example, the vehicle may be fuel-powered vehicle, a gas-powered vehicle or a new energy vehicle, and the new energy vehicle may be a pure electric vehicle, a hybrid vehicle or an extended-range vehicle, and the like.

In addition, the power consumption may be other energy storage apparatuses, such as mobile phones, portable devices, notebook computers, electronic toys, electric tools, ships, spacecrafts, and the like, where the spacecrafts include airplanes, rockets, space shuttles and spaceships, and the like.

The foregoing descriptions are merely a part of embodiments of the present application, and are not intended to limit the present application. For those skilled in the art, the present application may have various modifications and variations. Any modification, equivalent substitution, improvement etc., made within the spirit and principle of the present application shall fall within the protection scope of the present application.

1. A top cover assembly, comprising: a top cover plate, the top cover plate being provided with a mounting hole, and the mounting hole comprising a sealing hole section; a pole, comprising a first section, a second section and a sealing shaft section, wherein the sealing shaft section is configured to be inserted into the sealing hole section, a side wall of the sealing hole section and a side wall of the sealing shaft section are both tilted with respect to an axis of the mounting hole, the first section directly extends from a bottom end of the pole to the sealing shaft section and has a cylindrical shape, the second section directly extends from a top end of the pole to the sealing shaft section and has a cylindrical shape, a diameter of the first section is greater than a diameter of the second section, the first section transitions to the second section through the sealing shaft section, the sealing shaft section is tapered in a direction pointing from the first section towards the second section, a maximum diameter of the sealing shaft section is equal to the diameter of the first section, and a minimum diameter of the sealing shaft section is equal to the diameter of the second section; a sealing ring, disposed between the side wall of the sealing hole section and the side wall of the sealing shaft section; and a first insulating member and a second insulating member, wherein the first insulating member is located on a side of the top cover plate facing towards the first section of the pole, and the second insulating member is located on a side of the top cover plate facing towards the second section of the pole;
the first insulating member is provided with a restraint protrusion extending into the mounting hole and located between the side wall of the mounting hole and the second section of the pole; the restraint protrusion of the first insulating member, an end of the second insulating member facing towards the pole, the side wall of the sealing hole section, and the side wall of the sealing shaft section together define a sealing cavity, a top boundary of the sealing cavity being defined by a bottom surface of the restraint protrusion, a first lateral boundary of the sealing cavity being defined by the side wall of the sealing shaft section, a second lateral boundary of the sealing cavity being defined by the side wall of the sealing hole section, a bottom boundary of the sealing cavity being defined by a top surface of the second insulating member, the sealing ring being entirely disposed within the sealing cavity in a compressed state.

2. The top cover assembly according to claim 1, wherein along a direction pointing from a bottom part to a top part of the top cover plate, the side wall of the sealing hole section and the side wall of the sealing shaft section are both tilted in a direction close to the axis of the mounting hole.

3. The top cover assembly according to claim 1, wherein the side wall of the sealing hole section and the side wall of the sealing shaft section are tilted with respect to the axis of the mounting hole at an angle of 5° to 45°.

4. The top cover assembly according to claim 1, wherein along a thickness direction of the top cover plate, a distance between the side wall of the sealing hole section and the side wall of the sealing shaft section is the same everywhere.

5. The top cover assembly according to claim 1, wherein a generatrix of the sealing hole section and a generatrix of the sealing shaft section are both straight lines, and the generatrix of the sealing hole section is parallel to the generatrix of the sealing shaft section.

6. The top cover assembly according to claim 1, wherein a thickness of the sealing ring is less than or equal to a thickness of the top cover plate.

7. The top cover assembly according to claim 1, wherein a gap is left between at least one top corner of the sealing cavity and the sealing ring.

8. The top cover assembly according to claim 1, wherein a first end of the mounting hole has a first diameter, a second end of the mounting hole has a second diameter greater than the first diameter, the first insulating member being disposed at the first end of the mounting hole; the mounting hole further comprises a restraint hole section, and the restraint hole section is disposed at an end of the sealing hole section facing the first insulating member, and communicated with the sealing hole section; and the restraint protrusion is located between the restraint hole section and the pole.

9. The top cover assembly according to claim 1, wherein the top cover plate is made of an insulating material.

10. The top cover assembly according to claim 8, wherein a diameter of the restraint hole section is equal to a minimum diameter of the sealing hole section.

11. The top cover assembly according to claim 8, wherein an obtuse angle is formed between an inner wall of the sealing hole section and an inner wall of the restraint hole section.

12. The top cover assembly according to claim 1, wherein the first insulating member, the second insulating member and the top cover plate are independent components.

13. The top cover assembly according to claim 1, wherein the pole is riveted to the top cover plate through a terminal board.

14. The top cover assembly according to claim 1, wherein the top cover plate is provided with an explosion-proof valve and an explosion-proof valve patch.

15. The top cover assembly according to claim 8, wherein an end of the restraint hole section away from the sealing hole section forms a flange, the first insulating member being provided with a positioning groove in which the flange is received.

16. The top cover assembly according to claim 1, wherein a bottom end of the pole is connected to an adapting sheet, the pole being connected to a tab of an electrode assembly of a secondary battery through the adapting sheet.

17. A secondary battery, comprising a top cover assembly;
wherein the top cover assembly comprises:a top cover plate, the top cover plate being provided with a mounting hole, and the mounting hole comprising a sealing hole section;a pole, comprising a first section, a second section and a sealing shaft section, wherein the sealing shaft section is configured to be inserted into the sealing hole section, a side wall of the sealing hole section and a side wall of the sealing shaft section are both tilted with respect to an axis of the mounting hole, the first section directly extends from a bottom end of the pole to the sealing shaft section and has a cylindrical shape, the second section directly extends from a top end of the pole to the sealing shaft section and has a cylindrical shape, a diameter of the first section is greater than a diameter of the second section, the first section transitions to the second section through the sealing shaft section, the sealing shaft section is tapered in a direction pointing from the first section towards the second section, a maximum diameter of the sealing shaft section is equal to the diameter of the first section, and a minimum diameter of the sealing shaft section is equal to the diameter of the second section;a sealing ring, disposed between the side wall of the sealing hole section and the side wall of the sealing shaft section; and a first insulating member and a second insulating member, wherein the first insulating member is located on a side of the top cover plate facing towards the first section of the pole, and the second insulating member is located on a side of the top cover plate facing towards the second section of the pole;
the first insulating member is provided with a restraint protrusion extending into the mounting hole and located between the side wall of the mounting hole and the second section of the pole;the restraint protrusion of the first insulating member, an end of the second insulating member facing towards the pole, the side wall of the sealing hole section, and the side wall of the sealing shaft section together define a sealing cavity, a top boundary of the sealing cavity being defined by a bottom surface of the restraint protrusion, a first lateral boundary of the sealing cavity being defined by the side wall of the sealing shaft section, a second lateral boundary of the sealing cavity being defined by the side wall of the sealing hole section, a bottom boundary of the sealing cavity being defined by a top surface of the second insulating member, the sealing ring being entirely disposed within the sealing cavity in a compressed state.

18. The secondary battery according to claim 17, further comprising a housing, and an electrode assembly, an accommodating cavity is formed inside the housing to accommodate the electrode assembly and an electrolyte.

19. A power consumption apparatus, comprising a secondary battery, wherein the secondary battery is configured to provide electric energy; and
the secondary battery comprises a top cover assembly; wherein the top cover assembly comprises: a top cover plate, the top cover plate being provided with a mounting hole, and the mounting hole comprising a sealing hole section; a pole, comprising a first section, a second section and a sealing shaft section, wherein the sealing shaft section is configured to be inserted into the sealing hole section, a side wall of the sealing hole section and a side wall of the sealing shaft section are both tilted with respect to an axis of the mounting hole, the first section directly extends from a bottom end of the pole to the sealing shaft section and has a cylindrical shape, the second section directly extends from a top end of the pole to the sealing shaft section and has a cylindrical shape, a diameter of the first section is greater than a diameter of the second section, the first section transitions to the second section through the sealing shaft section, the sealing shaft section is tapered in a direction pointing from the first section towards the second section, a maximum diameter of the sealing shaft section is equal to the diameter of the first section, and a minimum diameter of the sealing shaft section is equal to the diameter of the second section; a sealing ring, disposed between the side wall of the sealing hole section and the side wall of the sealing shaft section; and a first insulating member and a second insulating member, wherein the first insulating member is located on a side of the top cover plate facing towards the first section of the pole, and the second insulating member is located on a side of the top cover plate facing towards the second section of the pole; the first insulating member is provided with a restraint protrusion extending into the mounting hole and located between the side wall of the mounting hole and the second section of the pole; the restraint protrusion of the first insulating member, an end of the second insulating member facing towards the pole, the side wall of the sealing hole section, and the side wall of the sealing shaft section together define a sealing cavity, a top boundary of the sealing cavity being defined by a bottom surface of the restraint protrusion, a first lateral boundary of the sealing cavity being defined by the side wall of the sealing shaft section, a second lateral boundary of the sealing cavity being defined by the side wall of the sealing hole section, a bottom boundary of the sealing cavity being defined by a top surface of the second insulating member, the sealing ring being entirely disposed within the sealing cavity in a compressed state.
